(19) United States
(12) Patent Application Publication
(10) Pub. No.: US 2021/0302302 A1
(43) Pub. Date: Sep. 30, 2021

(54) METHOD AND SYSTEM FOR ABRASION TESTING OF MATERIALS

(71) Applicant: Raytheon Company, Waltham, MA (US)

(72) Inventors: William A. Wilson, Tucson, AZ (US); Sridhar K. Siddhamalli, Vail, AZ (US); Michael B. Smith, Tucson, AZ (US); Mitchell W. Bro, Tucson, AZ (US)

(21) Appl. No.: 16/830,815

(22) Filed: Mar. 26, 2020

(51) Int. Cl. G01N 19/06; B01D 46/00; B33Y 50/00; B29C 64/386; G01N 15/02

(52) U.S. Cl. CPC G01N 19/06; B01D 46/0041; B33Y 50/00; G01N 2015/03; G01N 15/0205; B01D 2279/00; B29C 64/386

(57) ABSTRACT

A method for abrasion testing of a material sample includes abrading a surface of the sample with a tribometer, then characterizing particles in a portion of the flowing air that is received in an airborne particle collector. The testing may be done in an enclosure or container, such as an enclosure in or simulating a clean room environment. The drawing of air into the enclosure may be done by a fan pushing in air through a filter, such as a high efficiency particulate air (HEPA) filter. The enclosure may have vents (or louvers) through which some of the outflow of air may be directed, to help maintain an even flow, for example a laminar flow, of air through the container, and in particular past where the tribometer abrades the test material. The method may allow for real-time characterization of the particles produced by the testing.

### FIELD OF THE INVENTION

The invention is in the field methods and systems for testing of materials for production of airborne particles, such as from abrasion or other physical interactions.

### DESCRIPTION OF THE RELATED ART

Prior methods for measurement of subvisible particulates generated during abrasion testing of materials for cleanroom use, was to perform a liquid particle count (LPC) on a surface that has been abraded using a subjective amount of force. This test method does not accurately capture subvisible particles, since only such particles remaining on the abraded surface are picked up by the liquid used in wiping down the abraded surface.

### SUMMARY OF THE INVENTION

The problem of measuring airborne subvisible particles may be addressed by using a method to capture airborne subvisible particles under controlled conditions.

A test chamber (enclosure) may be employed to channel clean high efficiency particulate air (HEPA) filtered air across a test sample that is abraded with a linear reciprocating tribometer, and into a subvisible airborne particle counter. The process may take place in an environmental chamber with HEPA filtered horizontal airflow providing positive chamber pressure to the outside environment as to not introduce unwanted particles. The test chamber/system and method gives the capability to conduct an accurate abrasion test for assessing the particulate generation of sample materials.

According to an aspect of the invention, a method for abrasion testing a material sample includes the steps of: abrading a surface of the material sample with a tribometer; during the abrading, flowing clean air past the material sample; receiving some of the flowing air in an airborne particle collector that is downstream of the material sample; and characterizing particles in the some of the flowing air, using the airborne particle collector.

According to an embodiment of any paragraph(s) of this summary, the abrading and the flowing air occur in a container.

According to an embodiment of any paragraph(s) of this summary, the container is an environmental chamber that meets ISO class 5 particle count equivalent IAW ISO 14644.

According to an embodiment of any paragraph(s) of this summary, the tribometer is fully within the container.

According to an embodiment of any paragraph(s) of this summary, the air flows from an inlet of the container on a first side of the container to an outlet to the airborne particle collector on a second side of the container that is opposite the first side.

According to an embodiment of any paragraph(s) of this summary, a fan at the inlet of the container pushes air in from outside the container.

According to an embodiment of any paragraph(s) of this summary, pushing of the air with the fan creates a positive pressure within the container, with pressure within the container greater than pressure in an environment outside of the container.

According to an embodiment of any paragraph(s) of this summary, wherein the method further includes filtering the air that is pushed in from outside the container.

According to an embodiment of any paragraph(s) of this summary, the filtering is performed using a high efficiency particulate air (HEPA) filter at the inlet of the container.

According to an embodiment of any paragraph(s) of this summary, the container includes louvers on the second side of the container, with some of the air flow directed through the louvers, thereby aiding in maintaining laminar flow through the container.

According to an embodiment of any paragraph(s) of this summary, wherein the method further includes adjusting the louvers to maintain the air flow as laminar flow.

According to an embodiment of any paragraph(s) of this summary, the airflow is in a substantially horizontal direction past the sample.

According to an embodiment of any paragraph(s) of this summary, the abrading includes abrading with a linear reciprocating tribometer as the tribometer.

According to an embodiment of any paragraph(s) of this summary, the characterizing the particles includes detecting subvisible particles produced by the abrading.

According to an embodiment of any paragraph(s) of this summary, the airborne particle collector is a laser airborne particle connector.

According to an embodiment of any paragraph(s) of this summary, the characterizing the particles is performed in real time.

According to an embodiment of any paragraph(s) of this summary, the material sample is a solid polymer or metal rigid material.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

The annexed drawings, which are not necessarily to scale, show various aspects of the invention.

FIG. 1 is a schematic diagram of a material testing system according to an embodiment of the invention.

FIG. 2 is a schematic diagram of a material testing system according to another embodiment of the invention.

FIG. 3 is a high-level flow chart of a method according to an embodiment of the invention.

FIG. 4 is a chart of IEST-STD-CC1246E product cleanliness levels.

FIG. 5 is a chart of ISO Class cleanroom classifications.

### DETAILED DESCRIPTION

A method for abrasion testing of a material sample includes abrading a surface of the sample with a tribometer, then characterizing particles in a portion of the flowing air that is received in an airborne particle collector. The testing may be done in an enclosure or container, such as an enclosure in or simulating a clean room environment. The drawing of air into the enclosure may be done by a fan pushing in air through a filter, such as a high efficiency particulate air (HEPA) filter. The enclosure may have vents (or louvers) through which some of the outflow of air may be directed, to help maintain an even flow, for example a laminar flow, of air through the container, and in particular past where the tribometer abrades the test material. The enclosure may have a shape that helps maintain even flow through the container. The method may allow for real-time characterization of the particles produced by the testing. The method may allow for better determination of suitability of materials, such as additively-manufactured materials, for use in a clean-room environment.

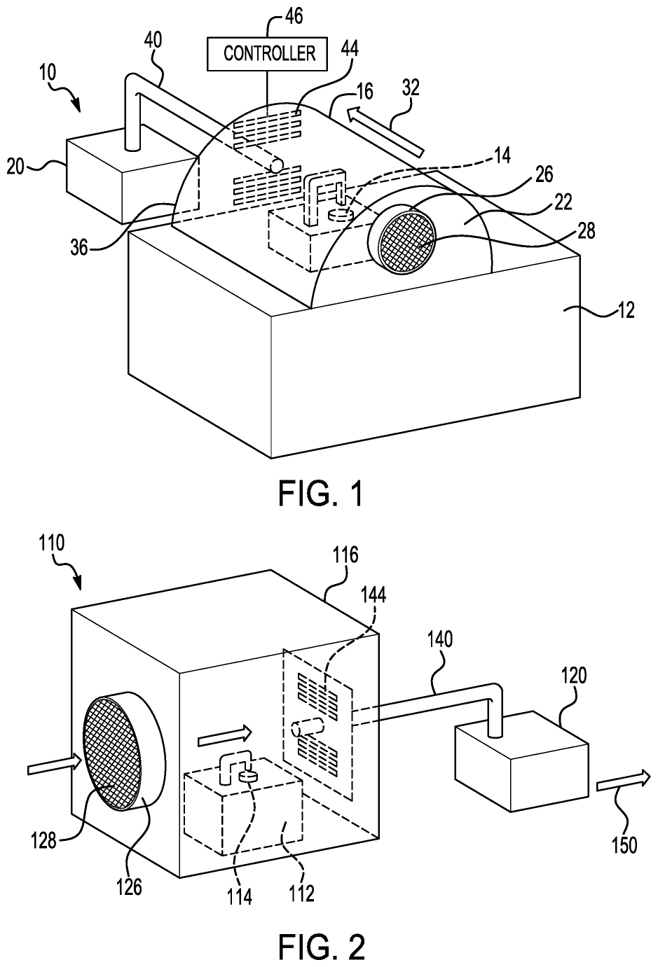

FIG. 1 shows a system 10 for materials testing in a clean environment. The system 10 includes a tribometer 12 for abrading a material sample 14, with the abrading occurring inside an enclosure or container 16. During the abrading air actively flows past the material sample 14, with some of the flowing air captured by an airborne particle counter 20 that is downstream of the material sample 14. The particle counter 20 can provide a real-time readout, characterizing the particles produced by abrasion of the test material sample 14, for example to help determine suitability of the material for use in a clean environment, such as a clean-room environment, for example an ISO 14644-1 class equivalent environmental chamber.

The system 10 may have features to keep the flow past the tribometer 12 and sample 14 even and repeatable. For example it may desirable to keep the air flow laminar where the abrading occurs, and downstream of where the abrading occurs, in order to provide predictable and repeatable results of the testing. Toward that end the enclosure 16 may have a shape and configuration that minimizes or eliminates corners, baffles, or other features that may cause recirculation of flow or sudden changes in flow direction, and/or may result in particle entrapment within the enclosure 16.

Toward that end, the enclosure 16 may have a curved shape that reduces the number and severity of corners. For example the enclosure 16 may have a half-cylinder shape. The enclosure 16 may be made of a suitable material, such as clear electrostatic discharge (ESD) safe plastic or ESD safe acrylic material. At an upstream wall 22 of the enclosure 16, there may be a fan 26 that pushes air in from outside the enclosure 16 through a filter 28, such as a high efficiency particulate air (HEPA) filter. The use of the fan 26 to push air into the enclosure 16 sets up a positive pressure within the enclosure 16. The filtered air proceeds in a flow direction 32 through the enclosure 16, past the material sample 14, and to a downstream wall 36. At the downstream wall 36 there is a passage (ESD safe pipe or conduit) 40 that directs some of the flowing air to the particle counter or collector 20. The passage 40 may protrude out from the downstream wall 36 so as to sample the airflow away from any flow interference from the downstream wall 36.

The airflow rate through the enclosure may be chosen to provide suitable characteristics to the flow, such providing even laminar airflow, and at an airflow rate that does not overcome the airflow sampling rate of the particle counter 20.

The downstream wall 36 may have other openings, such as louvers 44, that allow some of the airflow passing through the enclosure 16 to exit the enclosure 16. The louvers 44 (or other vents) may be adjustable to allow variable amounts of flow therethrough. This may facilitate maintaining a laminar flow and/or a more uniform and/or controllable flow through the enclosure 16. The opening of the louvers 44 may be controlled by a controller 46, which may be operatively coupled to one or more motors (not shown) that adjust the opening of the louvers 44. The control may be active or passive, and may be based on any of a variety of suitable factors.

The air flow through the enclosure 16 and specifically past the material sample 14, may be substantially horizontal air flow. “Substantially horizontal” in this context means nearly horizontal without having to be exactly horizontal, and may be considered horizontal within some measure of error, such as within an angle of 0.1 degrees, 1 degree, or 5 degrees, to give non-limiting examples.

The tribometer 12 may be a linear reciprocating tribometer, such as a linear reciprocating tribometer made by Anton Paar. As used herein, a tribometer may be defined as a machine that scratches/pulls a sitting mass against a sample material, under predetermined conditions, such as with a predetermined force between a part of the tribometer (such as the sitting mass) against a surface of the sample material. Thus the sample material will be subject to abrasion or other surface force, that may produce damage and result in the release of particles of the material. In a linear reciprocating tribometer a part of the tribometer moves back and forth across a material sample under specified force, for example scratching or abrading the sample material. It will be appreciated that a wide variety of tribometers may be suitable for carrying out the test on the material sample 14.

The particle counter/collector 20 may be any of a variety of suitable airborne particle counters that are able to detect subvisible particles or other small particles, and preferably able to relay results in real time. The particle collector 20 may be a laser particle collector that uses light to characterize the airborne particles received, such by particle size and frequency or number of particles received for various size ranges. An example of a suitable particle counter is the Apex Z50 portable airborne particle counter.

The system 10 may be useful for determining the suitability of materials for use in clean environments, such as clean rooms. Materials that may be tested may include rigid materials, for example polymers and metals. The materials may be additively manufactured articles, with the polymers or metals being formed solid (rigid) parts made using additive manufacturing operations. Example additive manufacturing processes include fused-filament fabrication (FFF), also referred to as fused-deposition modeling (FDM); powder bed fusion (PBF); direct metal laser sintering (DMLS); electron beam melting (EBM); selective heat sintering (SHS); selective laser melting (SLM); and selective laser sintering (SLS).

FIG. 2 shows an alternative system 110, with a tribometer 112 in an enclosure 116, used for characterizing particles shed by a test material 114 as air flows past. The enclosure 116 is a rectangular enclosure, and a fan 126 pushes clean air (cleaned by passing through a filter 128) into the enclosure 116 and past the abraded/scratched test material 114, with some of the air (with possible airborne particles entrained) passing to a particle counter/collector 120, through a pipe or conduit 140. Air is exhausted from the airborne particle counter 120 at 150. This pushing of clean air into the enclosure 116 provides a positive pressure within the enclosure 116. The enclosure 116 may have louvers or vents 144 on its downstream end, which may be used to maintain substantially even, reproducible, and/or laminar horizontal or substantially horizontal flow through the enclosure 116. Aspects and details of the system 110 may be similar to those discussed above with regard to the system 10 (FIG. 1).

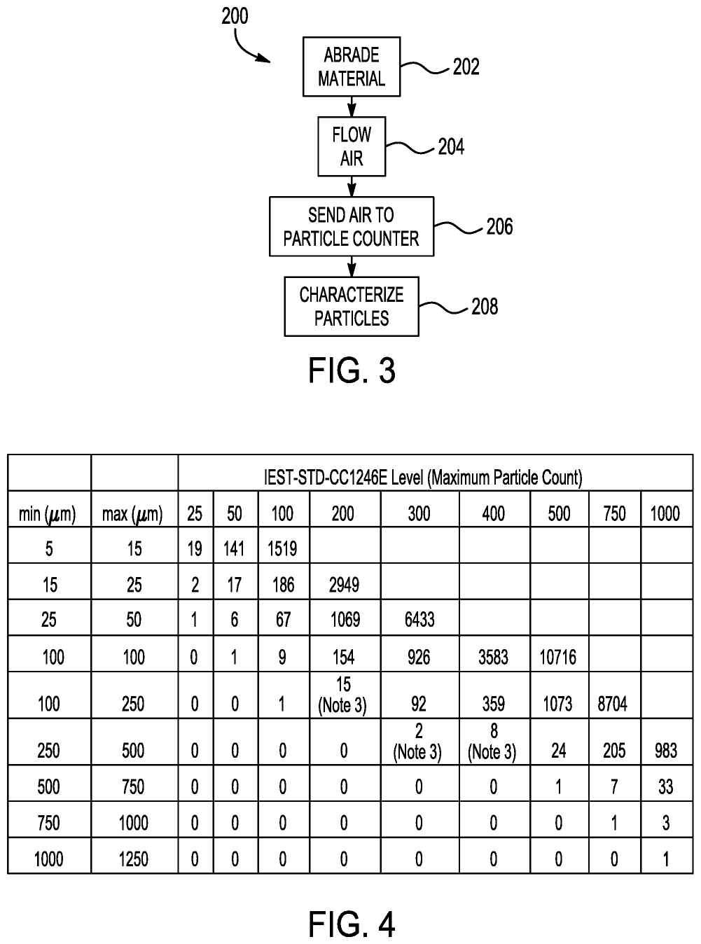

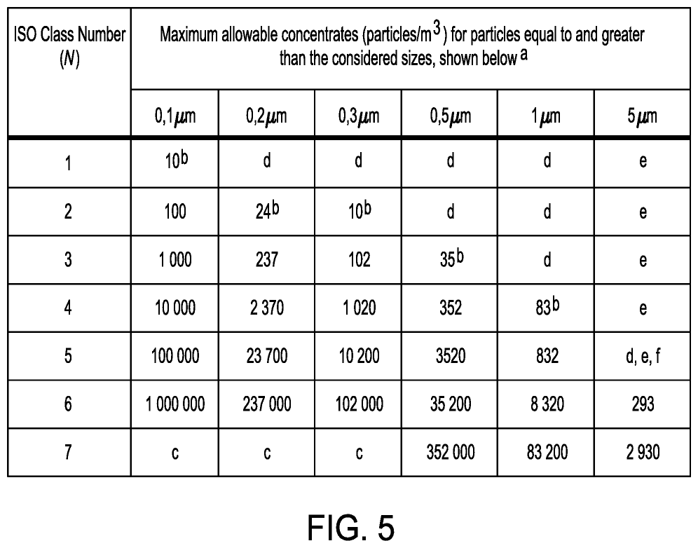

FIG. 3 shows a high-level flowchart of a method 200 for testing materials using a system such as the system 10 (FIG. 1) or the system 110 (FIG. 2). In step 202 the tribometer is used to abrade (or scratch, or otherwise physically interact with) the material sample. At the same time, in step 204, air flows through the enclosure of the system. In step 206 some of the air is received by the particle collector/container, downstream of the material sample. In step 208 the airborne particles received at the collector/container are characterized. For example, with reference to FIGS. 4 and 5, the number and size of the various types of particles received at the collector/container may be used to characterize the airborne particulate levels which have a direct correlation to surface level contamination as defined in IEST-STD-CC1246 (FIG. 4), or may be used to characterize the environmental cleanliness by ISO 14644 cleanroom classification (FIG. 5).

The methods and systems described offer advantages over previous methods/system. For example the airborne particles produced by abrasion can be accurately and repeatable characterized in real time. This may allow for better determination of the suitability of materials, such as additively-manufactured materials, for use in clean room environments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A method for abrasion testing a material sample, the method comprising:
abrading a surface of the material sample with a tribometer;
during the abrading, flowing clean air past the material sample;
receiving some of the flowing air in an airborne particle collector that is downstream of the material sample; and
characterizing particles in the some of the flowing air, using the airborne particle collector.

2. The method of claim 1, wherein the abrading and the flowing air occur in a container.

3. The method of claim 2, wherein the container is an environmental chamber that meets ISO class 5 particle count equivalent IAW ISO 14644.

4. The method of claim 3, wherein the tribometer is fully within the container.

5. The method of claim 2, wherein the air flows from an inlet of the container on a first side of the container to an outlet to the airborne particle collector on a second side of the container that is opposite the first side.

6. The method of claim 5, wherein a fan at the inlet of the container pushes air in from outside the container.

7. The method of claim 6, wherein pushing of the air with the fan creates a positive pressure within the container, with pressure within the container greater than pressure in an environment outside of the container.

8. The method of claim 7, further comprising filtering the air that is pushed in from outside the container.

9. The method of claim 8, wherein the filtering is performed using a high efficiency particulate air (HEPA) filter at the inlet of the container.

10. The method of claim 2, wherein the container includes louvers on the second side of the container, with some of the air flow directed through the louvers, thereby aiding in maintaining laminar flow through the container.

11. The method of claim 10, further comprising adjusting the louvers to maintain the air flow as laminar flow.

12. The method of claim 1, wherein the airflow is in a substantially horizontal direction past the sample.

13. The method of claim 1, wherein the abrading includes abrading with a linear reciprocating tribometer as the tribometer.

14. The method of claim 1, wherein the characterizing the particles includes detecting subvisible particles produced by the abrading.

15. The method of claim 1, wherein the airborne particle collector is a laser airborne particle connector; and

16. The method of claim 15, wherein the characterizing the particles is performed in real time.

17. The method of claim 1, wherein the material sample is a solid polymer or metal rigid material.

18. The method of claim 1, wherein the material sample is an additively manufactured material.
